(19) United States
(12) Patent Application Publication
(10) Pub. No.: US 2016/0179388 A1
(43) Pub. Date: Jun. 23, 2016

(54) METHOD AND APPARATUS FOR PROVIDING PROGRAMMABLE NVM INTERFACE USING SEQUENCERS

(71) Applicants: Yiren Ronnie Huang, San Jose, CA (US); Theodore Y. Lam, San Jose, CA (US)

(72) Inventors: Yiren Ronnie Huang, San Jose, CA (US); Theodore Y. Lam, San Jose, CA (US)

(73) Assignee: CNEXLABS, Inc., San Jose, CA (US)

(21) Appl. No.: 14/975,025

(22) Filed: Dec. 18, 2015

Related U.S. Application Data
(60) Provisional application No. 62/093,926, filed on Dec. 18, 2014.

(51) Int. Cl. G06F 3/06

(52) U.S. Cl. CPC G06F 3/0604; G06F 3/0629; G06F 3/064; G06F 3/0679

(57) ABSTRACT

One embodiment of the present application discloses a memory system using programmable sequencers to manage and/or communicate with non-volatile memory (“NVM”) devices with different specifications. The memory system capable of storing information includes a scheduler, NVM device, and programmable NVM interface (“PNI”). In one aspect, the PNI is a programmable sequencer or includes a programmable sequencer. The scheduler schedules a sequence of events or commands to implement memory access command(s). For instance, the scheduler can issue a scheduler command associated with a memory access in accordance with one or more instructions initiated from a memory controller. The NVM device stores information persistently. The PNI, in one embodiment, is configured to access information in the NVM device based on programmed operation code (“opcode”) stored in an opcode memory.

### PRIORITY

This application claims the benefit of priority based upon U.S. Provisional Patent Application Ser. No. 62/093,926, filed on Dec. 18, 2014 in the name of the same inventor(s) and having a title of “Method and Apparatus for Providing a Sequencer for Memory Access in Accordance with Opcode,” hereby incorporated into the present application by reference.

### FIELD

The exemplary embodiment(s) of the present invention relates to the field of semiconductor and integrated circuits. More specifically, the exemplary embodiment(s) of the present invention relates to storage and memory devices.

### BACKGROUND

A typical solid-state drive (“SSD”), which is also known as a solid-state disk, is a data storage memory device for persistently remembering stored information or data. Conventional SSD technology employs standardized interfaces or input/output (“I/O”) standards that may be compatible with traditional I/O interfaces for hard disk drives. In one example, SSD uses non-volatile memory (“NVM”) components to store and retrieve digital data for a digital processing device. In application, SSD may be connected to a computing system through various standard interfaces such as PCI express.

A problem associated with a conventional SSD or a cluster of conventional SSDs is that the NVM components in the SSD and the control of those NVM components can change often and rapidly. As well, different types of NVM components often require different types of specifications such as timing requirements. Typically, NVM devices with different specifications require different NVM controllers to handle and/or manage such NVM devices.

### SUMMARY

One embodiment of the present invention discloses a memory system using programmable sequencers to manage and/or programmably communicate with non-volatile memory (“NVM”) devices with different specifications. The memory system capable of storing information includes a scheduler, NVM device, and programmable NVM interface (“PNI”). In one aspect, the PNI is a programmable sequencer. Alternatively, the PNI includes a programmable sequencer or programmable micro-sequencer. The scheduler, in one example, schedules a sequence of events or commands to implement memory access command(s). For instance, the scheduler can issue a scheduler command associated with a memory access in accordance with one or more instructions initiated from a memory controller. The NVM device stores information persistently. The PNI, in one embodiment, is configured to access information in the NVM device based on programmed operation code (“opcode”) stored in an opcode memory.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a memory system configured to use programmable sequencer to manage various NVM devices in accordance with one embodiment of the present invention;

FIG. 2 is a logic diagram illustrating a portion of memory controller using programmable sequencer to provide programmable NVM interface in accordance with one embodiment of the present invention;

FIG. 3 is a block diagram illustrating a NAND-based flash sequencer (“NFS”) 300 for handling NAND based flash memory device(s) in accordance with one embodiment of the present invention;

FIG. 4 illustrates tables showing scheduler command format in accordance with one embodiment of the present invention;

FIG. 5 illustrates a table showing an exemplary sequencer opcode or instruction opcode in accordance with one embodiment of the present invention;

FIG. 6 is a logic flow diagram illustrating a multi-plane erase flow using sequencer opcode in accordance with one embodiment of the present invention;

FIG. 7 is a logic flow diagram illustrating a read status flow using sequencer opcode in accordance with one embodiment of the present invention;

FIG. 8 is a schematic diagram illustrating a circuit operable flash memory based physical interface (“PHY”) using sequencer opcode in accordance with one embodiment of the present invention;

FIG. 9 is a schematic diagram illustrating an exemplary system capable of implementing one aspect of programmable NVM interface in accordance with one embodiment of the present invention; and

FIG. 10 is a flowchart illustrating a process of providing programmable NVM interface using sequencers in accordance with one embodiment of the present invention.

### DETAILED DESCRIPTION

Exemplary embodiment(s) of the present invention is described herein in the context of a method, system and apparatus for managing and accessing non-volatile memory (“NVM”) devices using a programmable micro-sequencer(s).

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

References to “one embodiment,” “an embodiment,” “example embodiment,” “various embodiments,” “exemplary embodiment,” “one aspect,” “an aspect,” “exemplary aspect,” “various aspects,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “controller” is used generically herein to describe any number of components, elements, sub-systems, devices, packet switch elements, packet switches, routers, networks, computer, memory controller, SSD controller, and/or communication devices or mechanisms, or combinations of components thereof. The term “computer” is used generically herein to describe any number of computers, including, but not limited to personal computers, embedded processors and systems, control logic, ASICs, chips, workstations, mainframes, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to the block and flow diagrams, are typically performed in a different serial or parallel ordering and/or by different components and/or over different connections in various embodiments in keeping within the scope and spirit of the invention.

As used herein, the singular forms of article “a”, “an” and “the” are intended to include the plural forms as well, unless the context clearly indicates otherwise. Also, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

One embodiment of the presently claimed invention discloses a memory system using one or more programmable sequencers to manage and/or communicate with non-volatile memory (“NVM”) devices possessing one or more different or several unique specifications. The memory system capable of storing information includes a scheduler, NVM device(s), and programmable NVM interface (“PNI”). In one aspect, the PNI is a programmable sequencer. Alternatively, the PNI includes a micro-sequencer state machine, a set of registers, a sequencer operation code (“opcode”) memory, and a physical interface layer (“PIL”).

The scheduler, in one example, schedules a sequence of events or commands in connection to memory operations. For instance, the scheduler can issue a command associated with a memory access in accordance with one or more instructions initiated by a memory controller. The NVM device is able to store information persistently. The PNI, in one embodiment, is configured to access information in the NVM device based on programmed opcode which is stored in the sequencer opcode memory. The sequencer opcode, in one example, is programmed or generated based on the requirements of specification(s) associated with the NVM devices.

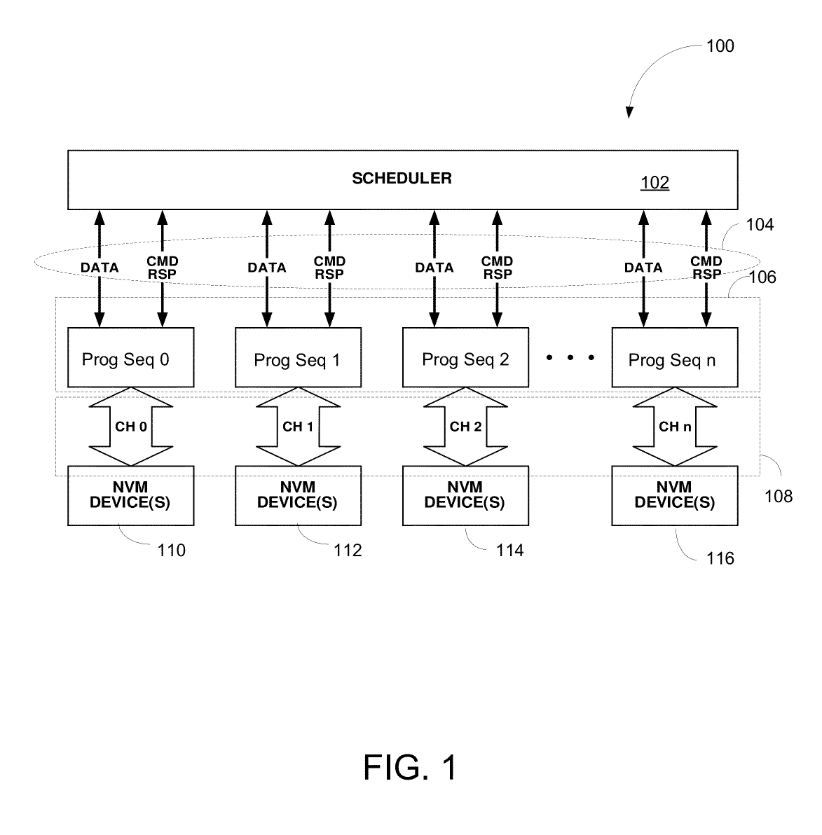

FIG. 1 is a block diagram 100 illustrating a memory system configured to use programmable sequencers to manage various NVM devices in accordance with one embodiment of the present invention. Diagram 100, in one aspect, is a programmable physical interface (“PPI”) which can be a part of memory controller configured to communicate with one or more NVM devices 110-116. NVM devices 110-116, in one example, can have the same or different specifications. PPI, in one aspect, includes a scheduler 102, programmable NVM interface (‘PNI”) 106, and a bus 108. Bus 108 further includes multiple channels such as (“CH0 to CHn”). In one aspect, the range of channels can be between 16 to 128 channels. It should be noted that the underlying concept of the exemplary embodiment(s) of the present invention would not change if one or more blocks (or devices) were added to or removed from PPI or diagram 100.

PPI 100, in one aspect, is responsible to provide an interface mechanism between a memory controller or upper level control layer(s) and a diverse range of existing and/or future NVM devices 110-116. It should be noted that memory operations generally begin at the upper level control layer such as memory control core in a memory control card. Upon receiving and parsing the memory operation(s) at scheduler 102, PNI 106 which contains one or more programmable sequencers begins to process the memory operation(s). The PIL which contains one or more PHY modules generates finally results capable of driving, fluctuating, and/or wiggling voltage levels at various pins connected to NVM devices 110-116 based on programmable sequencer opcode.

Scheduler 102, in one example, is configured to distribute tasks or parsed memory operations and improves bus and/or channel efficiency. Upon receipt of a memory operation such as a write data command, scheduler 102 is capable of parsing or converting the memory operation into scheduler commands, sequencer opcode, micro-code, or simple protocol instructions. Each scheduler command is composed of a series of simple protocol instructions. A function of scheduler 102 is to ensure each physical channel such as CH0 is efficiently utilized. To increase bus efficiency, operations on any one channel can interleave NVM command sequences associated to a particular command thread (such as a READ) with any other command thread (such as a write) so the channel is always kept busy. In one aspect, multiple sets of data and control buses 104 are used to couple between scheduler 102 and PNI 106.

PNI 106 includes multiple programmable sequencers or programmable micro-sequencers such as programmable sequencer (0) (“prog seq 0”) to prog seq n. Each sequencer such as prog seq 0, in one aspect, translates received scheduler commands to the actual changing of signals or voltage levels at the pins of hardware interface. To accommodate multiple protocols such as ONFI (Open NAND Flash Interface) or Toggle Mode, the sequencer is programmable to implement various different specifications required by different NVM devices 110-116. For example, the different specification includes multiple data rates, asynchronous single data rate (“SDR”), double data rate (“DDR”), different vendor timing parameters, and/or potential extendable requirements. The same circuit may be utilized to implement NVM devices with the same specifications as well. The sequencer, in one aspect, includes a micro-coded engine to implement such specifications. The pattern and timing of signal changes for each scheduler command is stored as sequencer opcode in an instruction RAM (random access memory). Note that the opcode or sequencer opcode can be reprogrammed at any time through a firmware upgrade. The programmability of sequencer provides flexibility and extensibility of the NVM components. It should be noted that the opcode or code for sequencer can be generated in an assembly language by a special NVM interface assembler.

The PIL, not shown in FIG. 1, includes one or more PHY blocks or models that are principally hardware components and are dedicated to changing the sequencer signals into physical voltages. In addition, the PIL provides a swizzle interface which connects pins to one or more NVM devices 110-116. A feature of swizzle interface is to provide pin connectivity flexibility and reordering using configuration registers. Note that functional reordering may occur at the sequencer or sequencer layer.

Employing PPI 100 enables an NVM controller to support up to n number of physical interfaces, where n is an integer such as 16, 32, or 64. Each NVM interface has a separate sequencer with its own microcode. Individual programmable sequencer within the NVM interface allows a possibility of using different types of memories or NVM devices for each physical channel even though a single multi-threaded scheduler is used to issue the scheduler commands.

An advantage of using PPI is to allow in-field firmware upgrading and customization. Another advantage of using PPI is to enhance memory performance including multi-LUN (logic unit), multi-die interleaving, low-level intra-LUN interleaving, multi-plane read/write/erase interleaving, and cache read/write interleaving.

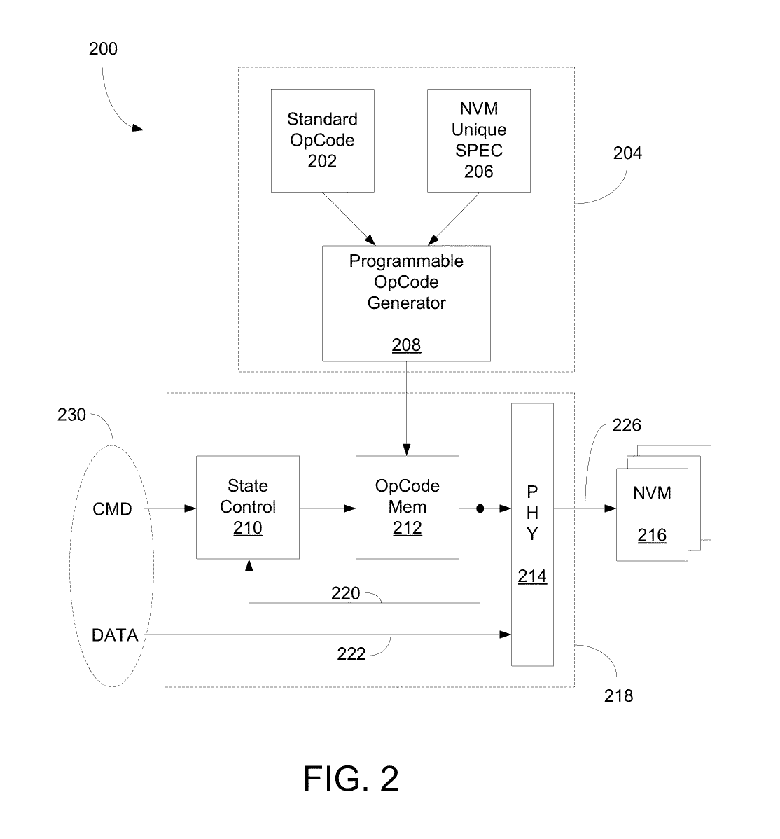

FIG. 2 is a logic diagram 200 illustrating a portion of memory controller using the programmable sequencer to provide programmable NVM interfacing in accordance with one embodiment of the present invention. Diagram 200 includes an assembler 204, NVM devices 216, and PNI 218. In one example, PNI 218 is further coupled to a scheduler not shown in diagram 200. NVM devices 216, in one aspect, can include different types of NVM components with different types of control specifications. Specifications include the necessary operational requirements, such as, but not limited to, data type, writing timing, reading timing, eraser timing, control timings, data rate, voltage levels, and NVM types. It should be noted that the underlying concept of the exemplary embodiment(s) of the present invention would not change if one or more blocks (or devices) were added to or removed from diagram 200.

Assembler 204, also known as microcode assembler, includes a standard opcode component 202, NVM unique specification (“spec”) component 206, and programmable opcode generator 208. Standard opcode 202, for example, can be a buffer storing a predefined general opcode for predefined NVMs. In one aspect, standard opcode 202 is situated within the memory controller. Alternatively, standard opcode 202 can be located in a memory section outside of memory controller. NVM unique spec component 206 can also be a buffer storing special requirement(s) for a particular NVM device(s). Programmable opcode generator 208, in one aspect, is able to generate a unique set of sequencer opcode specifically for communicating with attached NVM such as NVM device(s) 216 based on inputs or data from standard opcode 202 and NVM unique spec 206.

In operation, programmable opcode generator 208 fetches a set of instructional opcode from standard opcode 202 and retrieves another set of NVM specific requirements from NVM unique spec component 206. Based on the set of instructional opcode and set of NVM specific requirements, programmable opcode generator generates a set of sequencer opcode which is capable of handling communication between NVM devices 216 and the scheduler (not shown in FIG. 2). The set of sequencer opcode is stored in an opcode memory 212 in PNI 218.

A scheduler not shown in diagram 200 is operable to manage data channels for memory access to and from NVM devices such as devices 216. The scheduler is capable of issuing scheduler commands or commands (“CMD”) and data 230 associated with memory operations according to one or more instructions initiated by a memory controller, not shown in diagram 200. In one aspect, the scheduler distributes memory operations to sixteen (16) NVM devices substantially simultaneously via sixteen (16) PNIs 218. In an alternative aspect, a PNI such PNI 218 can handle multiple NVM devices with multiple specifications.

NVM devices 216, in one aspect, are operable to store information persistently. For example, NVM device 216 includes NAND based flash memory device able to maintain stored data without power supply. Alternatively, NVM device includes phase-change memory device capable of persistently storing data without power supply. It should be noted that any other types of NVM components may be used instead of flash memory and/or phase-change memory.

PNI 218, in one aspect, includes a state control component 210, opcode memory 212, and a PHY layer or block 214. PNI 218 is coupled between a scheduler (not shown in FIG. 2) and NVM device(s) 216. A function of PNI is to access information in NVM device 216 based on a section of programmed sequencer opcode stored in opcode memory 212. The section of the programmed sequencer opcode is composed based on scheduler command 230. PNI 218 also includes at least one physical channel 226 which is used to couple PNI 218 to NVM device 216 for facilitating device communication.

In one aspect, state control component 210 includes a micro-coded sequencer configured to perform the function of state machine to perform memory operations. For example, based on one of the scheduler commands, state control 210 executes a section of sequencer opcode stored in opcode memory 212 and fluctuates voltage levels at input pins of NVM devices 216 via PHY block 214 based on the execution of the section of sequencer opcode.

PHY block 214, in one example, is configured to facilitate communication between PNI 218 and NVM device 216 via pins or I/O pins. A function of PHY block 214 is to vary, wiggle, change, or fluctuate voltage levels at the I/O pins of NVM device 216 according to the sequencer opcode. The programmable sequencer opcode is stored in opcode memory 212 which can be a random access memory (“RAM”), read-only memory (“ROM”), or a combination of RAM and ROM depending on the applications.

In one aspect, while one scheduler is used to provide distribution of memory operations to a cluster of NVM devices such as NVM devices 216 via 16 channels, each channel couples to a PNI such as PNI 218 and an NVM device such as NVM device 216. Assembler 204 is configured to generate the sequencer opcode, microcode, or assembly code in accordance with NVM specifications of the NVM device 216. PNI 218, in one example, also includes a program counter used to point the execution location of the opcode stored in opcode memory 212.

An advantage of using PNI is that it can be programmed via sequencer opcode to adopt variation of specifications due to different NVM components used in the NVM devices.

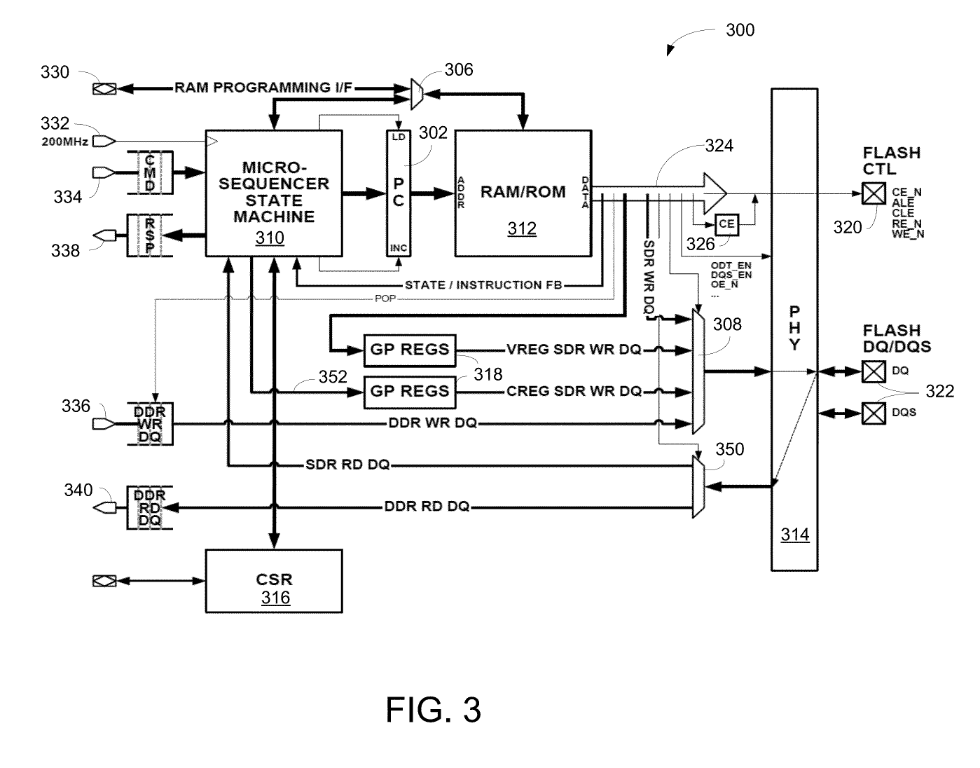

FIG. 3 is a block diagram illustrating a NAND-based flash sequencer (“NFS”) 300 for handling NAND based flash memory device(s) in accordance with one embodiment of the present invention. NFS 300, which is a PNI configured for handling NAND-based NVM or flash based NVM, includes a micro-sequencer state machine 310, program counter (“PC”) 302, opcode memory 312, PHY block 314, and a set of general purpose (“GP”) registers 318. NFS 300 further includes multiple input/output (“I/Os”) 330-340 used to communicate with the scheduler, not shown in diagram 200. I/O pins or I/O ports 320-322 are used to communicate with the NVM devices, not shown in diagram 200. In one aspect, I/O ports 320-322 can be exemplary I/O ports for the NVM devices. It should be noted that the underlying concept of the exemplary embodiment(s) of the present invention would not change if one or more blocks (or devices) were added to or removed from NFS 300.

A sequencer or programmable sequencer, in one example, includes a micro-sequencer state machine 310, PC 302, and opcode memory 312. Alternatively, a sequencer includes a micro-sequencer state machine 310, PC 302, opcode memory 312, and PHY block 314. In one example, one sequencer is dedicated to a channel which is coupled to one or more NVM devices. To simplify forgoing discussion, the terms “sequencer”, “micro-sequencer”, and “programmable sequencer” are referred to the similar components and they can be used interchangeably.

Micro-sequencer state machine or state machine 310, in one aspect, is a sequencer or microsequencer capable of driving or controlling voltage levels at I/O pins 320-322 using addresses stored in PC 302 to step through a section of micro-program or sequencer opcode stored in opcode memory 312. Upon receiving scheduler commands (“CMDs”) from a scheduler via I/O 334, state machine 310 is able to parse CMDs based on sequencer opcode stored in opcode memory 312. After forwarding a response (“RSP”) to the scheduler to acknowledge the receipt of CMDs, state machine 310 sets up an opcode index in PC 302 based on the result of parsing CMDs and control (or feedback) signals such as state/instruction feedback from opcode memory 312.

Opcode memory 312, which can be a RAM or ROM or a combination of RAM and ROM, stores sequencer opcode or microprogram generated by an assembler via I/O 330. In one aspect, the sequencer opcode can also be programmed based on the information partially from state machine 310 via a multiplexer 306. The output of opcode memory 312 includes a set of control signals and data (“DQ”). The control signals includes, but not limited to, read_enable (“RE_N”), write_enable (“WE_N”), address_enable (“ALE”), and command enable (“CLE”). PC 302, in one example, is a counter which can be set during a parsing process of CMDs by state machine 310.

NFS 300, in one aspect, depicts a data path traveling from sequencer or state machine 310 to I/O pins 320-322 via one or more PHY blocks 314. CMDs are sent to state machine 310 through an FIFO-based interface via I/O 334. The sequencer responds by a sending a RSP (response) or ACK (acknowledgement) signal back to the scheduler via another FIFO-based interface via I/O 338. The response from the scheduler includes information about which thread and what command has completed. Note that a separate data path interface can be established for high speed data transfers involving, for example, burst DDR (double data rate) read data or burst DDR write data.

When a scheduler CMD is received, the sequencer, in one example, uses the opcode of the CMD as an index into a dispatch table. PC 302 is subsequently loaded with the result identified in the dispatch table. Once PC 302 is set, the sequencer begins running code from an instruction RAM or opcode memory 312. Note that code execution continues until a STOP instruction is reached, at which point the sequencer sends RSP data back to the scheduler.

The sequencer, in one aspect, instructs PHY block 314 on each clock cycle how the interface pins such as I/O pins 320-322 should be changed. PHY block 314 takes sequencer instructions and actually changes voltage levels on the pins which include, for example, expanding a single signal such as the data strobe into true, and a complement version of signal if differential signaling is used.

In operation, upon receiving a CMD via I/O 334, state machine 310 parses the CMD and composes a set of sequencer opcode based on the parsing results. After sending an RSP/ACK to the scheduler, state machine 310 passes payloads to GP register 318 as indicated by numeral 352. After setting up index value at PC 320, sequence control passes from sequence command to ROM (or opcode memory) 312. In one aspect, a lookup table is used to identify the counter value. ROM or sequencer opcode begins to drive voltage levels at various pins via PHY block 314 based on the opcode. The index or pointer value in PC 302 is continuously updated via a feedback loop from ROM. After obtaining an end of sequence (“EOS”) instruction, the control passes from ROM to sequence command and ROM ends the execution steps. State machine 310 subsequently sends an RSP/ACK message back to the scheduler to indicate the completion of the CMD.

In one aspect, the sequencer is a micro-coded state machine 310 with aspects of a traditional CPU, but also uses special vector instructions that facilitate manipulating to various hardware pins. The upper half of ROM is a 16-bit Sequencer Instruction (“SI”) used to govern the control path. The control path can be used to write internal registers, waiting for a predefined time, reading data, looping pass existing code, or calling subroutines. The lower half of ROM is a 16-bit Vector Instruction (“VI”) which is capable of changing the configuration of pins on the data path. In one example, a 1-to-1 mapping between a bit of VI and a pin of interface. If, for example, the value of bit is ‘1’, the corresponding pin will be high or logic “1”. Similarly, if the value is ‘0’, the corresponding pin will be low or logic “0”. Some VI bits are devoted to choosing the source data for outgoing commands. Examples of possible 8-bit data sources include information, such as row and column addresses, flash memory opcode, write_data for a set parameter command, and/or general purpose registers pre-loaded with specific values via microcode.

The instruction RAM or sequencer opcode memory 312 can be any size. The first 32 of 512 entries are reserved for the dispatch table that converts the scheduler CMD opcode into address(s) of Instruction RAM in which the code execution will begin. The sequencer's ability to use loops and call subroutines improves code density.

An advantage of using NFS 300 is that it allows its sequencer opcode to be updated or changed to accommodate the requirements of attached NVM devices. Note that NFS 300 is able to handle both DDR data as well as SDR data.

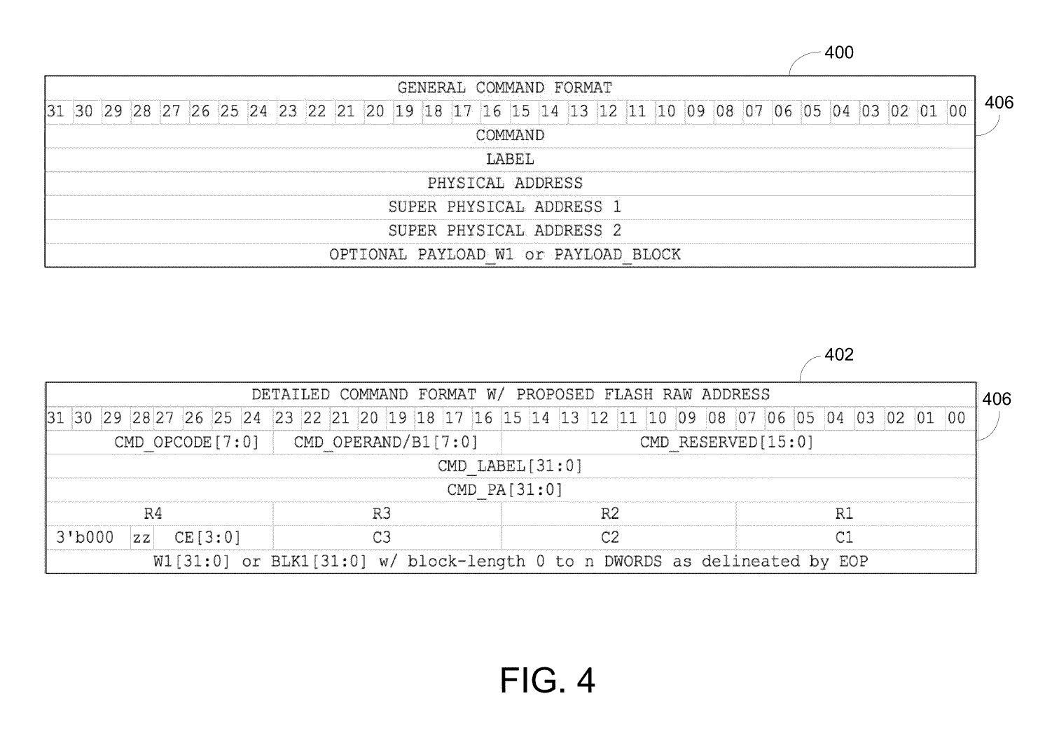

FIG. 4 illustrates tables 400-402 showing a scheduler command format in accordance with one embodiment of the present invention. Table 400 shows an exemplary command format while table 402 illustrates a detailed format. Note that a CMD with command format shown in tables 400-402 is sent from the scheduler module to the sequencer module. In one example, the width of each command or command field is 32 bits wide. According to table 402, command field 406 is divided between an 8-bit OPCODE and an optional 8-bit operand named B1. The OPCODE field is referred to as generalized protocol operation, such as Erase Execute, to undertake. The Label field is a unique ID that is used by the scheduler to recognize a completed command when it is returned in the response data from the sequencer.

The physical page address used in the SSD Controller is to identify a unique NVM address. The super physical address 1 (SPA1) field is a physical address that can be presented to the NVM memory array and is derived from the physical page address. The calculation of R1, R2, and R3 with optional R4 (row) values is indicated by the scheduler. The super physical address 2 (SPA2) field is another physical address field that can be presented to the NVM memory array and is derived from the physical page address. The calculation of C1 and C2 with optional C3 is indicated by the scheduler. The calculation of which chip enable to activate on a channel is initiated by a scheduler.

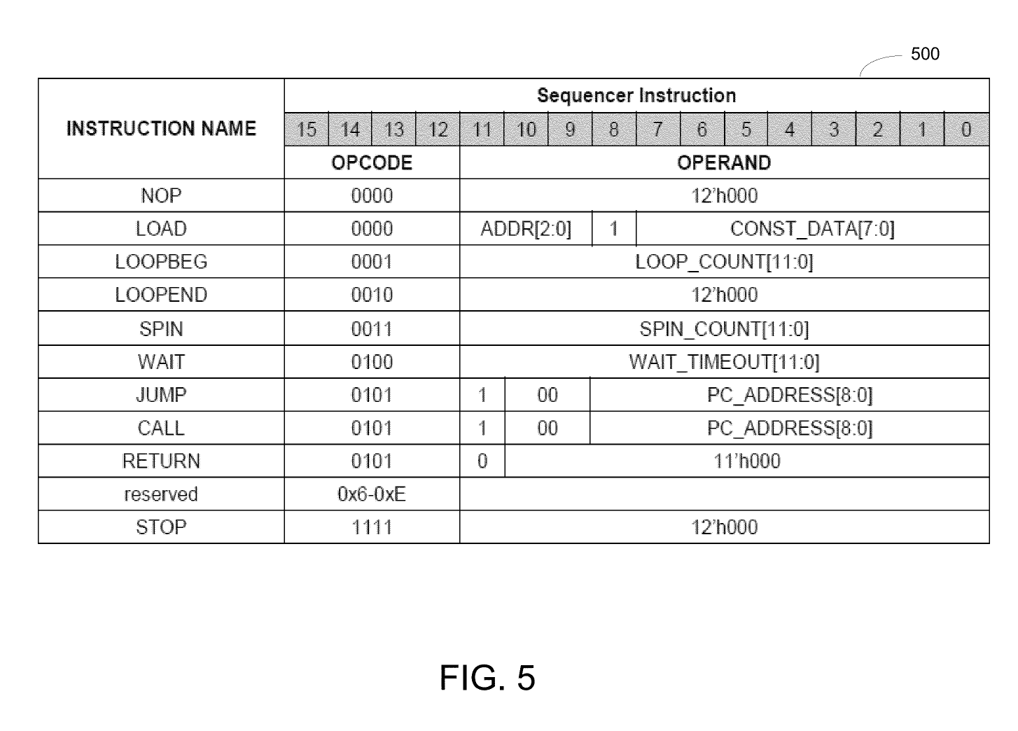

FIG. 5 illustrates a table 500 showing an exemplary sequencer opcode or instruction opcode in accordance with one embodiment of the present invention. Table 500 illustrates an instruction name column and sequencer instruction column. The sequencer instruction column further divided into an opcode column and operand column. In one aspect, a combination of 10 sequencer opcodes are used to implement CMDs. As shown in table 500, a set of micro codes is used to control the micro coded sequencer. Exemplary micro codes or sequencer codes includes NOP, LOAD, SPIN, LOOPBEG (loop being), LOOPEND (loop end), JUMP, CALL, RETURN, and the like. It should be noted that the underlying concept of the exemplary embodiment(s) of the present invention would not change if one or more sections (or opcodes) were added to or removed from table 500.

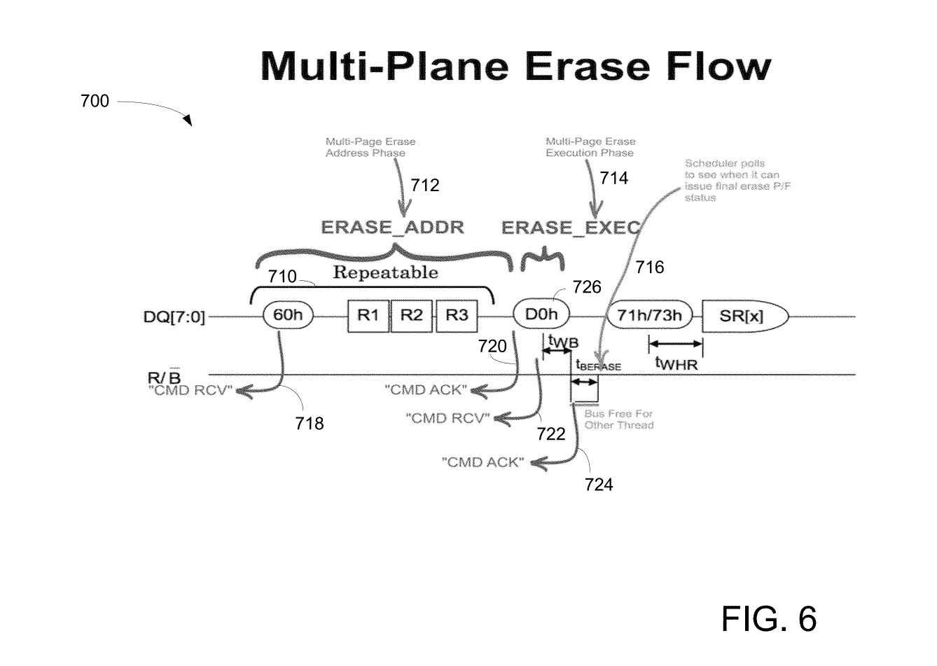

FIG. 6 is a logic flow diagram 700 illustrating a multi-plane erase flow using sequencer opcode in accordance with one embodiment of the present invention. Diagram 700 is an exemplary protocol flow to operate multi-plane erase flow. Based on received scheduler CMD opcode, the flow illustrates a flash memory erase operation. Diagram 700 also shows how a scheduler CMD can expand through sequencer code to perform multiple sequential bus operations to achieve intended CMD operation(s). It should be noted that the underlying concept of the exemplary embodiment(s) of the present invention would not change if one or more steps (or repeats) were added to or removed from diagram 700.

Upon receiving a CMD for erase operation to a flash memory or NVM device as indicated by numeral 718, multi-page erase address phases 712 is initiated and proceeded. To properly identify erase address(s), multiple repeatable sequential steps 710 operated according to sequencer opcode is implemented. In one example, multi-page erase address phase 712 repeats row addresses such as R1, R2, and R3. Upon identifying the erase address(s), a CMD ACK (acknowledgement) message is sent back to the CMD issuer (the scheduler) as indicated by numeral 720. After receiving multi-page erase execution CMD 722, a set of sequential opcode implementing erase execution 714 is initiated and a CMD RCV signal is sent to the scheduler. Once the erase execution is completed, a CMD ACK message 724 is sent. At 716, the scheduler polls to see when the scheduler can issue a final erase status which indicates whether the bus should be released for other thread.

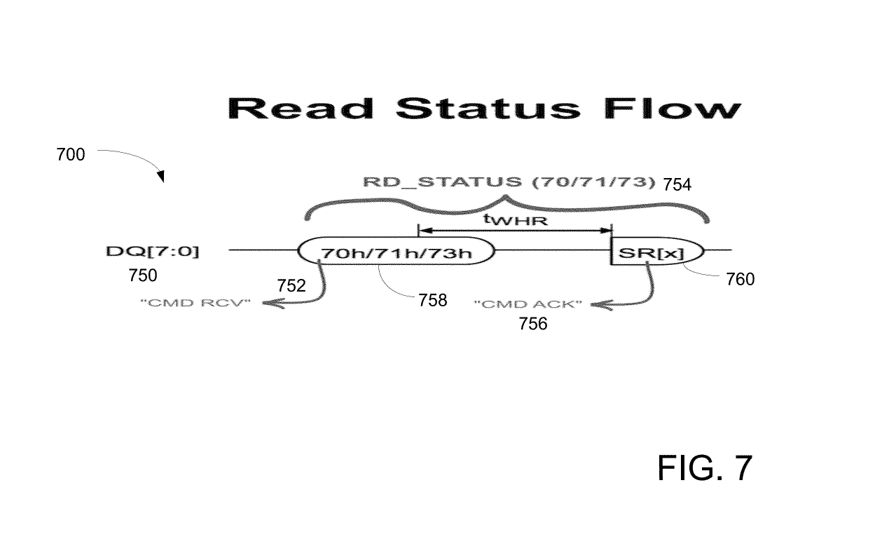

FIG. 7 is a logic flow diagram 700 illustrating a read status flow using sequencer opcode in accordance with one embodiment of the present invention. Upon receiving a CMD for read status operation to a flash memory or NVM device as indicated by numeral 752, read status instruction 754 is initiated. After the execution of the read status operation, a CMD ACK message 756 is sent back to the CMD issuer (the scheduler).

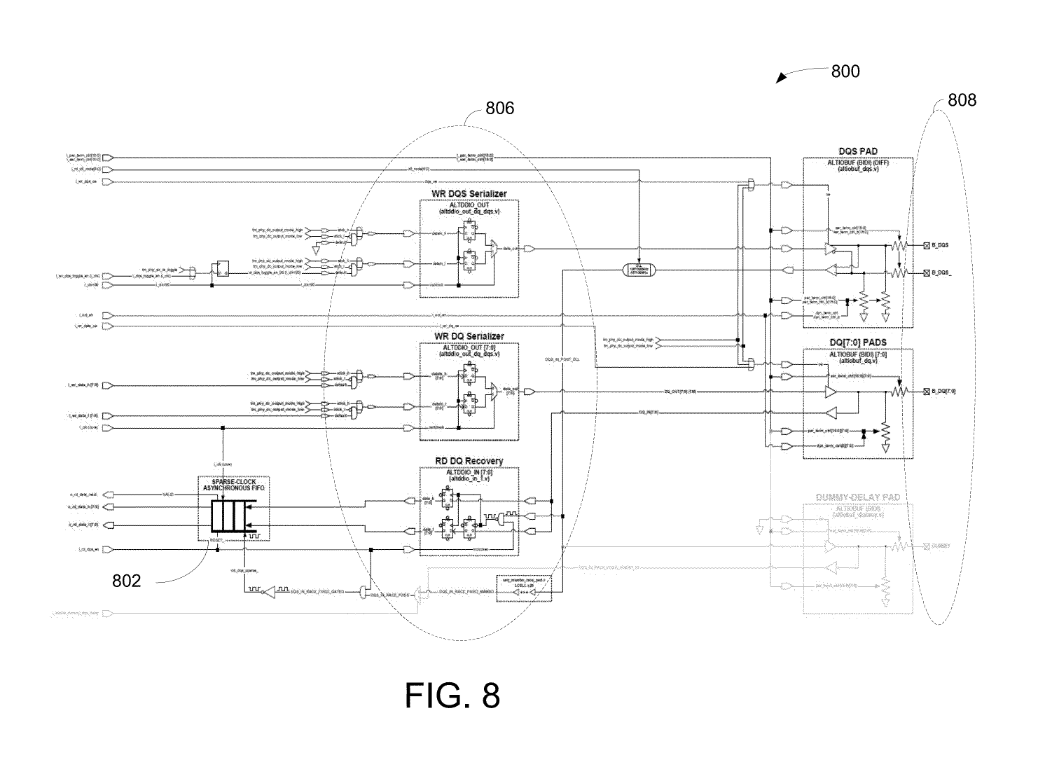

FIG. 8 is a schematic diagram 800 illustrating a circuit operable flash memory based physical interface (“PHY”) in accordance with one embodiment of the present invention. Diagram 800 includes a buffer 802, serializers 806, and pins 808. Serializers 806 further include write serializers which are capable of fluctuating voltage levels at pins 808. Also, serializers 806 include read recovery which is able to sense voltage levels from pins 808. It should be noted that the underlying concept of the exemplary embodiment(s) of the present invention would not change if one or more steps (or repeats) were added to or removed from diagram 800.

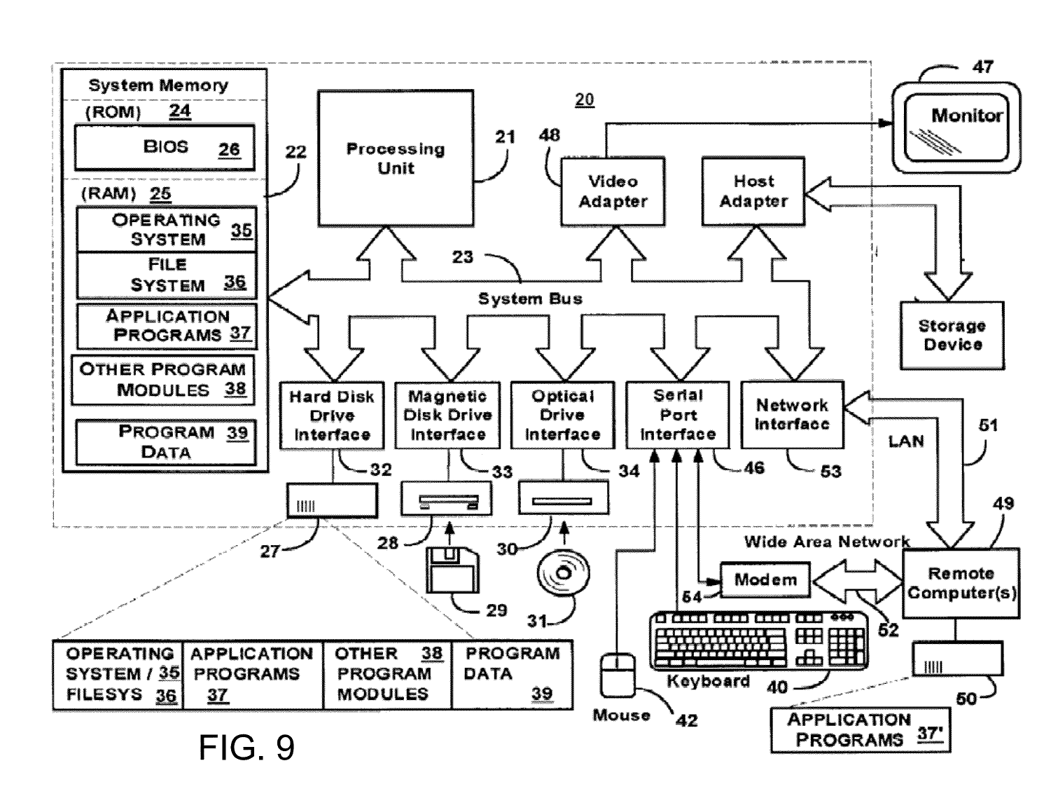

FIG. 9 is a block diagram illustrating an exemplary system capable of implementing one aspect of programmable NVM interface in accordance with one embodiment of the present invention. The system includes a general purpose computing device in the form of a personal computer (or a node) 20 or server or the like, including a processing unit 21, a system memory 22, and a system bus 23 that couples various system components including system memory 22 and processing unit 21. System bus 23 can be any of several types of bus structures including a memory bus or memory controller, a peripheral bus, and a local bus using any of a variety of bus architectures. The system memory includes read-only memory (ROM) 24 and random access memory (RAM) 25.

A basic input/output system 26 (BIOS), containing the basic routines that help to transfer information between elements within computer 20, such as during start-up, is stored in ROM 24. Personal computer/node 20 may further include a SSD or a hard disk drive for reading from and writing to a hard disk, not shown, a magnetic disk drive 28 for reading from or writing to a removable magnetic disk 29, and an optical disk drive 30 for reading from or writing to a removable optical disk 31 such as a CD-ROM, DVD-ROM or other optical media.

The hard disk drive, magnetic disk drive 28, and optical disk drive 30 are connected to system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for personal computer 20. In one aspect, computer 20 also includes an SSD for storage wherein the SSD is able to activate the embodiment of GC process to improve the performance of SSD. In one embodiment, interface 32 includes PPI capable of programming sequencer opcode to communicate multiple different types of NVM devices.

Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35 (preferably WINDOWS™). Computer 20 includes a file system 36 associated with or included within operating system 35, such as the WINDOWS NT™ File System (NTFS), one or more application programs 37, other program modules 38 and program data 39. A user may enter commands and information into computer 20 through input devices such as a keyboard 40 and pointing device 42.

Other input devices (not shown) may include a microphone, joystick, game pad, satellite dish, scanner or the like. These and other input devices are often connected to processing unit 21 through a serial port interface 46 that is coupled to the system bus, but may be connected by other interfaces, such as a parallel port, game port or universal serial bus (USB). A monitor 47 or other type of display device is also connected to system bus 23 via an interface, such as a video adapter 48.

In addition to monitor 47, personal computers typically include other peripheral output devices (not shown), such as speakers and printers. A data storage device, such as a SSD, a hard disk drive, a magnetic tape, or other type of storage device is also connected to system bus 23 via a host adapter via a connection interface, such as Integrated Drive Electronics (IDE), Advanced Technology Attachment (ATA), Ultra ATA, Small Computer System Interface (SCSI), SATA, Serial SCSI and the like.

Computer 20 may operate in a networked environment using logical connections to one or more remote computers 49. Remote computer (or computers) 49 may be another personal computer, a server, a router, a network PC, a peer device or other common network node, and typically includes many or all of the elements described above relative to computer 20. Computer 20 may further include a memory storage device 50. The logical connections include a local area network (LAN) 51 and a wide area network (WAN) 52. Such networking environments are commonplace in offices, enterprise-wide computer networks, Intranets and the Internet. When used in a LAN networking environment, computer 20 is connected to local area network 51 through a network interface or adapter 53.

When used in a WAN networking environment, personal computer 20 typically includes a modem 54 or other means for establishing communications over wide area network 52, such as the Internet. Modem 54, which may be internal or external, is connected to system bus 23 via serial port interface 46. In a networked environment, program modules depicted relative to personal computer 20, or portions thereof, may be stored in the remote memory storage device. It will be appreciated that the network connections shown are exemplary and other means of establishing a communications link between the computers may be used.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

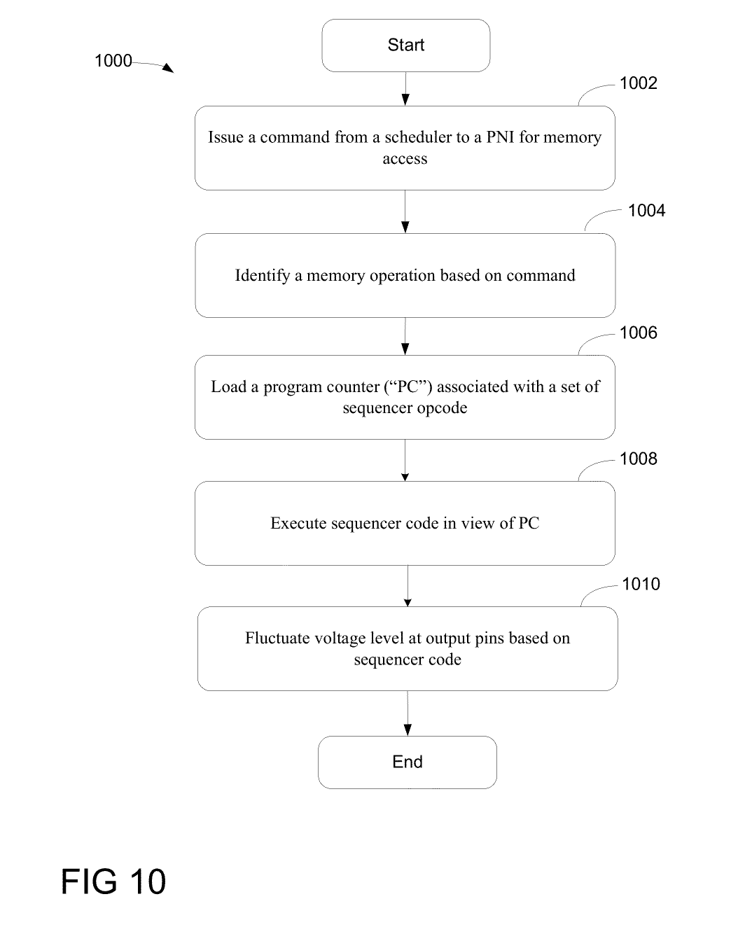

FIG. 10 is a flowchart illustrating a process of providing programmable NVM interface using sequencers in accordance with one embodiment of the present invention. At block 1002, a process capable of accessing NVM device(s) issues a command from a scheduler to a PNI for memory access. For example, a memory access request such as memory write operation is sent to a sequencer or a state machine.

At block 1004, a memory operation and NVM location are identified based on the command. For example, the process is able to determine memory operations, such as write page, erase, and/or memory read.

At block 1006, the PC is loaded for executing at least a portion of sequencer opcode. The execution of sequencer opcode implements a memory operation indicated by the command.

At block 1008, the process is capable of executing a set of sequencer codes stored in an instruction memory pointed by the PC. In one aspect, the process of executing sequencer codes continues until a stop instruction is encountered.

At block 1010, the process, in one aspect, is able to fluctuate or wiggle the voltage level(s) at one or more output pins of a memory interface based on the set of sequencer opcode. The process is also able to program, update, change sequencer codes in accordance with interface specifications of NVM devices. Note that the process is capable of setting a voltage level that represents logic state one (1) at an I/O pin connected to an NVM device.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A memory system able to store information for a computing apparatus, comprising:
a scheduler operable to manage data channels for memory access and configured to issue a plurality of scheduler commands associated with memory operations in accordance with one or more instructions initiated by a memory controller;
a non-volatile memory (“NVM”) device operable to store information persistently; and
a programmable NVM interface (“PNI”), coupled to the scheduler and the NVM device, configured to include an operation code (“opcode”) memory and a physical interface (“PHY”) block, the PNI operable to access information in the NVM device based on programmed sequencer opcode stored in the opcode memory in response to the plurality of the scheduler command.

2. The system of claim 1, further comprising at least one physical channel coupled between the PNI and the NVM device facilitating communication.

3. The system of claim 1, wherein the PNI includes a micro-coded sequencer configured to perform a function of state machine of timing sequence to perform memory operations to the NVM device based on one of the plurality of scheduler commands.

4. The system of claim 1, wherein the PHY block is configured to facilitate communication between the PNI and the NVM device via a plurality of pins.

5. The system of claim 4, wherein the PHY block is able to vary voltage levels via the plurality of the pins in accordance with a set of sequencer opcode.

6. The system of claim 1, further comprising:
a second NVM device operable to store information persistently; and
a second PNI, coupled to the scheduler and the second NVM device, configured to include a second opcode memory and a second PHY block, the second PNI operable to access information in the second NVM device based on second programmed sequencer opcode stored in the second opcode memory in response to the plurality of the scheduler command.

7. The system of claim 6, wherein the scheduler is capable of scheduling memory operations to sixteen (16) NVM devices substantially simultaneously.

8. The system of claim 1, wherein the NVM device includes NAND based flash memory device able to maintain stored data without power supply.

9. The system of claim 1, wherein the NVM device includes phase-change memory device capable of storing data without power supply.

10. The system of claim 1, further comprising an assembler configured to generate the sequencer opcode in accordance with NVM specifications of the NVM device.

11. The system of claim 1, wherein the opcode memory is a random-access memory (“RAM”).

12. The system of claim 1, wherein the PNI further includes a micro sequencer state machine and a program counter.

13. A method for accessing non-volatile memory (“NVM”), comprising:
issuing a command from a scheduler to a programmable NVM interface (“PNI”) for memory access;
identifying a memory operation and an NVM location based on the command;
generating a set of sequence operation code (“opcode”) for the memory operation in accordance to programmed sequencer opcode stored in a local memory;
loading a program counter (“PC”) associated with the set of sequencer opcode;
executing the set of sequencer opcode in accordance with the PC; and
fluctuating voltage level at one or more output pins of a memory interface based on the set of sequencer opcode.

14. The method of claim 13, further comprising programming the sequencer opcode according to interface specifications of NVM device.

15. The method of claim 13, wherein issuing a command from a scheduler to a PNI includes sending a memory access request to a sequencer.

16. The method of claim 13, wherein identifying a memory operation includes determining one of write page operation, erase operation, and read operation.

17. The method of claim 13, wherein executing the set of sequencer opcode stored in an instruction memory includes continuing executing a set of sequence code until a stop instruction is reached.

18. The method of claim 13, wherein fluctuating voltage level at one or more output pins includes setting a voltage level representing logic state one (1) at an output pin connected to an address line of the NVM device.

19. A memory system, comprising:
a scheduler configured to issues a plurality of commands associated with memory access in accordance with instructions from a memory controller;
a plurality of non-volatile memory (“NVM”) devices operable to store information persistently; and
a plurality of programmable sequencers, coupled to the scheduler and the plurality of NVM devices, configured to access information in the plurality of NVM devices based on operation code (“opcode”) stored in a plurality of random-access memories (“RAMs”) in response to the plurality of commands, wherein opcode are programmed in accordance with interface specifications of the plurality of NVM devices.

20. The memory system of claim 19, wherein each of the plurality of programmable sequencers includes a micro-sequencer state machine configured to provide a set of sequencer opcode to perform one of the plurality of the commands.

21. The memory system of claim 19, wherein each of the plurality of RAMs is configured to provide NVM control signals and data signals to one of the plurality of NVM devices.
